(19) United States
(12) Patent Application Publication
(10) Pub. No.: US 2016/0279523 A1
(43) Pub. Date: Sep. 29, 2016

(54) SYSTEM AND METHOD FOR INTERACTIVE GAMING

(71) Applicant: GAMEin30 Ltd., Tel Aviv (IL)

(72) Inventors: Guy ALTAGAR, Tel Aviv (IL); Asaf ALTAGAR, Tel Aviv (IL)

(21) Appl. No.: 14/834,495

(22) Filed: Aug. 25, 2015

Related U.S. Application Data
(60) Provisional application No. 62/138,057, filed on Mar. 25, 2015.

(51) Int. Cl. A63F 13/795; G06F 3/0482; G06F 3/0489; G06F 3/0481

(52) U.S. Cl. CPC A63F 13/795; G06F 3/04817; G06F 3/0482; G06F 3/0489

(57) ABSTRACT

A system and method for gaming may include integrating, in a display of a soft keyboard, a display of a plurality of gaming icons for initiating a respective plurality of interactive games. In response to a selection of a game icon by an inviter, the inviter and an invitee may be engaged in an interactive game. A system and method may, in response to a selection of a game icon included in a soft keyboard, send, from an inviter to an invitee, an invitation to participate in an interactive game. An invitation may include a link usable by an invitee to participate in an interactive game. A plurality of invitations may be sent to a plurality of invitees.

### CROSS-REFERENCE TO RELATED APPLICATIONS

This application claims benefit of U.S. Provisional Patent Application No. 62/138,057, filed Mar. 25, 2015, which is incorporated in its entirety herein by reference.

### FIELD OF THE INVENTION

The present invention relates generally to gaming. More specifically, the present invention relates to interactive online gaming.

### BACKGROUND OF THE INVENTION

Interactive online gaming is known in the art. Interactive online gaming is facilitated by applications, products and services on digital computing and/or mobile devices that enable users to play interactive games using their computing and/or mobile devices. For example, interactive online games, mobile games or video games are played using a computing device such as a feature phone, smartphone, smartwatch, personal digital assistant (PDA), tablet, portable media player, etc.

In some cases, mobile games are distributed over the air (OTA), for example, a game binary file is delivered to the mobile device via wireless carrier networks. In other cases (known in the art as “Side loaded”), a game binary file is loaded onto the phone while connected to a PC, either via USB cable or Bluetooth. In yet other cases (known in the art as “Pre-installed”), a game binary file is preloaded onto the device by an original equipment manufacturer (OEM). Other methods may enable direct downloading, e.g., game file is downloaded directly from a website. For example, mobile games are downloaded at app stores as well as via the mobile operator's network.

However, current system and methods do not readily enable users to engage in an interactive game from within an application. In particular, current system and methods do not enable a user to use a soft keyboard (e.g., a soft keyboard used for entering text) in order to engage in an interactive game.

### SUMMARY OF THE INVENTION

A system and method for gaming may include integrating, in a display of a soft keyboard, a display of a plurality of gaming icons for initiating a respective plurality of interactive games. In response to a selection of a game icon by an inviter, the inviter and an invitee may be engaged in an interactive game. A system and method may, in response to a selection of a game icon included in a soft keyboard, send, from an inviter to an invitee, an invitation to participate in an interactive game. An invitation may include a link usable by an invitee to participate in an interactive game. A plurality of invitations may be sent to a plurality of invitees.

A system and method may include presenting to an inviter a list of potential invitees, the list including at least one of: a contact in a contact list, a friend in a social network, a user currently using a specific online application and a predefined list.

A system and method may include selecting at least some of the plurality of interactive games icons based on at least one of: a profile of an inviter and a profile of an invitee. A system and method may generate an invitation usable by an invitee for a limited time period.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1A shows high level block diagram of an exemplary computing device according to embodiments of the present invention;

FIG. 1B shows a system and flows according to some embodiments of the invention;

FIG. 2 shows flow of game initiation in a social gaming platform according to some embodiments of the invention;

FIG. 3 shows flow of game initiation in a social gaming platform according to some embodiments of the invention;

FIG. 4A shows an exemplary screenshot according to some embodiments of the invention;

FIG. 4B shows an exemplary screenshot according to some embodiments of the invention;

FIG. 5A shows an exemplary screenshot according to some embodiments of the invention;

FIG. 5B shows an exemplary screenshot according to some embodiments of the invention;

FIG. 6 shows an exemplary layout of a screen presented to a user in accordance with some embodiments of the invention; and

FIG. 7 shows a flowchart of a method according to an embodiment of the present invention.

It will be appreciated that, for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

A system and method according to some embodiments of the invention may enable distribution, marketing and access to mobile games via user applications. In particular, by embedding a button in a soft keyboard, the button usable for inviting and enabling users to play a game, a system and method according to some embodiments of the invention may provide a quick and attractive way to invite a friend to play.

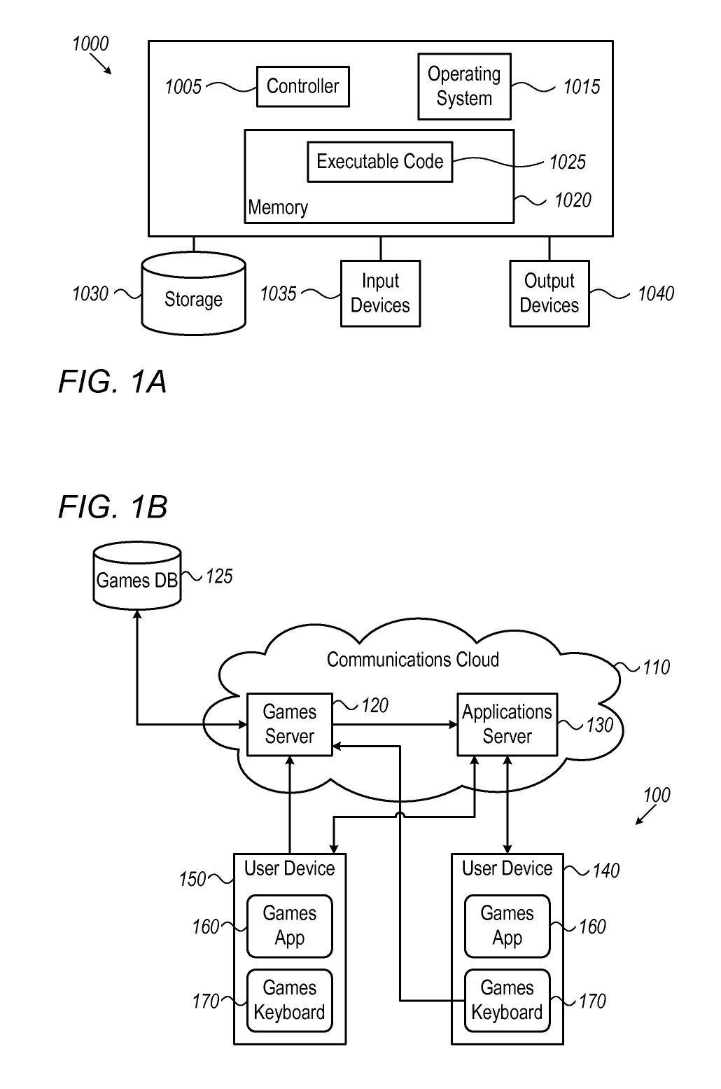

Reference is made to FIG. 1A, showing a high level block diagram of an exemplary computing device 1000 according to some embodiments of the present invention. For example, user devices 140 and 150 described herein may be, or may include components of, computing device 1000. Computing device 1000 may include a controller 1005 that may be, for example, a central processing unit processor (CPU), a chip or any suitable computing or computational device, an operating system 1015, a memory 1020, an executable code 1025, a storage 1030, input devices 1035 and output devices 1040. Controller 1005 may be configured to carry out methods described herein, and/or to execute or act as the various modules, units, etc. More than one computing device 1000 may be included, and one or more computing devices 1000 may act as the various components, for example the components shown in FIG. 1B. For example, user device 140 described herein may be, or may include components of, computing device 1000. For example, by executing executable code 1025 stored in memory 1020, controller 1005 may be configured to carry out a method of gaming as described herein. For example, controller 1005 may be configured to include, in a display of a soft keyboard, a display of a plurality of gaming icons for initiating a respective plurality of interactive games and, in response to a selection of a game icon by an inviter, engaging the inviter and an invitee in an interactive game as described herein.

Operating system 1015 may be or may include any code segment (e.g., one similar to executable code 1025 described herein) designed and/or configured to perform tasks involving coordination, scheduling, arbitration, supervising, controlling or otherwise managing operation of computing device 1000, for example, scheduling execution of software programs or enabling software programs or other modules or units to communicate. Operating system 1015 may be a commercial operating system.

Memory 1020 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 1020 may be or may include a plurality of, possibly different memory units. Memory 1020 may be a computer or processor non-transitory readable medium, or a computer non-transitory storage medium, e.g., a RAM.

Executable code 1025 may be any executable code, e.g., an application, a program, a process, task or script. Executable code 1025 may be executed by controller 1005 possibly under control of operating system 1015. For example, executable code 1025 may be an application that includes or integrates, in a display of a soft keyboard, a display of a plurality of gaming icons for initiating a respective plurality of interactive games and, in response to a selection of a game icon by an inviter, engages the inviter and an invitee in an interactive game as further described herein. Although, for the sake of clarity, a single item of executable code 1025 is shown in FIG. 1A, a system according to embodiments of the invention may include a plurality of executable code segments similar to executable code 1025 that may be loaded into memory 1020 and cause controller 1005 to carry out methods described herein. For example, units or modules described herein (e.g., games application 160 and keyboard application 170) may be, or may include, controller 1005, memory 1020 and executable code 1025.

Storage 1030 may be or may include, for example, a hard disk drive, a floppy disk drive, a Compact Disk (CD) drive, a CD-Recordable (CD-R) drive, a Blu-ray disk (BD), a universal serial bus (USB) device or other suitable removable and/or fixed storage unit. Content may be stored in storage 1030 and may be loaded from storage 1030 into memory 1020 where it may be processed by controller 1005. In some embodiments, some of the components shown in FIG. 1A may be omitted. For example, memory 1020 may be a non-volatile memory having the storage capacity of storage 1030. Accordingly, although shown as a separate component, storage 1030 may be embedded or included in memory 1020.

Input devices 1035 may be or may include a mouse, a keyboard, a touch screen or pad or any suitable input device. It will be recognized that any suitable number of input devices may be operatively connected to computing device 1000 as shown by block 1035. Output devices 1040 may include one or more displays or monitors, speakers and/or any other suitable output devices. It will be recognized that any suitable number of output devices may be operatively connected to computing device 1000 as shown by block 1040. Any applicable input/output (I/O) devices may be connected to computing device 1000 as shown by blocks 1035 and 1040. For example, a wired or wireless network interface card (NIC), a printer, a universal serial bus (USB) device or external hard drive may be included in input devices 1035 and/or output devices 1040.

Some embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 1020, computer-executable instructions such as executable code 1025 and a controller such as controller 1005.

Some embodiments may be provided in a computer program product that may include a non-transitory machine-readable medium, stored thereon instructions, which may be used to program a computer, controller, or other programmable devices, to perform methods as disclosed herein. Some embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including, semiconductor devices such as read-only memories (ROMs) and/or random access memories (RAMs), flash memories, electrically erasable programmable read-only memories (EEPROMs) or any type of media suitable for storing electronic instructions, including programmable storage devices. For example, in some embodiments, memory 1020 is a non-transitory machine-readable medium.

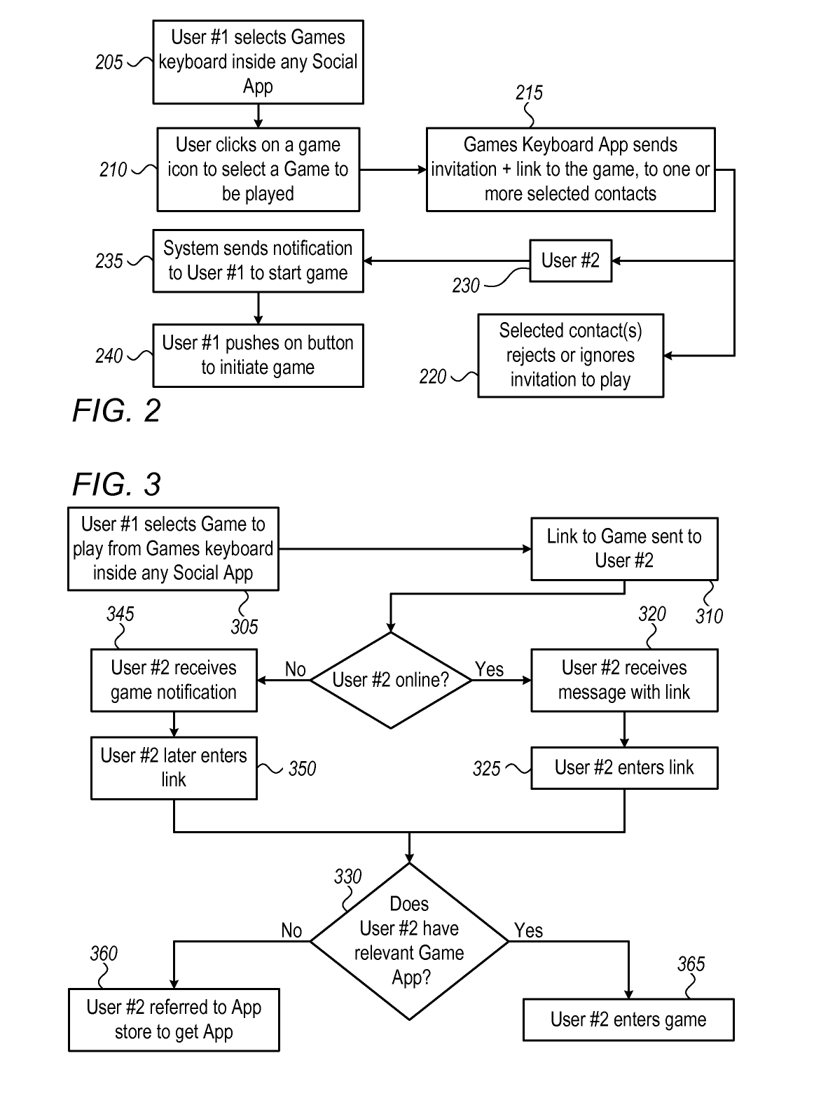

A system according to some embodiments of the invention may include components such as, but not limited to, a plurality of central processing units (CPU) or any other suitable multi-purpose or specific processors or controllers (e.g., controllers similar to controller 1005), a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a workstation, a server computer, a network device, or any other suitable computing device. For example, a system as described herein may include one or more devices such as computing device 1000.

Where applicable, units shown by blocks 160 and 170, and other components and units described herein, may be similar to, or may include components of, device 1000 described herein. For example, games applications 160 and keyboard application 170 may be or may include a controller 1005, memory 1020 and executable code 1025. For example, units shown in FIG. 2 and elsewhere may be tasks or applications executed by controller 1005.

The terms “game” and “gaming” as used herein may refer to digital and/or online games and gaming as known in the art. Games as referred to herein may be individual or multiplayer games, challenge games, educational games, money games, community based games, browser-based games, live synchronous tournaments, turn-based asynchronous tournaments, or other interactive games or entertainment used substantially simultaneously by multiple end users. Games may be online synchronic or a-synchronic games as known in the art.

The term “social applications” as used herein refers to applications run on mobile devices or other computing or communication devices that enable instant messaging, online chat, real time text or multimedia transmission, VoIP, video chat file transfer, multicast transmission, etc., using either peer to peer or client-server protocols. The term “touch screen device” as used herein may refer to a stationary or portable multifunction device, user interfaces for such devices, and associated processes for using such devices, including but not limited to mobile telephones, wearable device, smart watches, tablets, phablets, notebooks, PDS's, music player or game player devices, etc.

On most common touch screen devices, the user interfaces may include soft keyboard. A soft keyboard as known in the art is a graphical user interface (GUI) object usable for inputting, or operable to input, text characters, gestures, emoji characters etc. A soft keyboard may include standard keyboard that includes characters, symbols and numbers (e.g., a QWERTY keyboard as known in the art) and/or non-standard configurations of symbols on the displayed icons of the keyboard. Icons are known in the art, as referred to herein, icons may be graphical objects (pictograms) displayed on a screen of a computing device and may be used to activate applications or performed other operations when clicked. As known in the art, a soft keyboard may be configurable. For example, it is common to configure a soft keyboard to support multiple languages or include selected icons.

Some embodiments of the present invention may include a platform and method for facilitating cross platform gaming. In some embodiments, a platform and methods are provided for initiating substantially real-time multi-user gaming from substantially any social application operated on a touch screen device. In some embodiments, a dedicated dynamic gaming soft keyboard is provided to enable distribution of games via the soft keyboard, as well as access to games from a remote device via the soft keyboard, via existing user applications. The gaming soft keyboard, in some embodiments, may be integrated into a touch screen device by an OEM, via an application download, plug-in, extension etc.

Some embodiments of the present invention may provide a device, platform, method and user interface for enabling touch screen device gaming. An embodiment of a system and method may include, on an electronic device with a touch screen display, displaying a predefined keyboard display area operable to display a plurality of gaming icons for initiating a game; and in response to detecting the selection of a game icon, connecting a first user to a game server to launch a game. Some embodiments of the present invention may connect a first and second users, and enable the users to engage or participate in an online game. For example, and in response to detecting the selection of a game icon, an embodiment may connect a first user to a second user by causing both users to engage in an on line game.

In a further embodiment, multiple users, a group of users, and multiple groups of users may be connected in response to, or upon detecting a selection of a game icon. For example, in response to detecting the selection of a game icon, a plurality of users may be notified or invited to a game as described herein. In some embodiments, the connection of a first user to a second user is over (or in) a social application, using the first user's connections contactable through the social application.

A system and method according to some embodiments of the invention may include running one or more files with instructions to present a soft gaming keyboard as part of a user interface on a display area of a device, the soft keyboard including a plurality of gaming icons. Upon clicking on an icon by a first user, a system and method according to some embodiments of the invention may initiate an invitation to play the selected game with one or more selected contacts.

Upon selecting one or more contacts, an embodiment may communicate a request (or invitation) to play the selected game with the first user, and upon receiving an acceptance of the request or invitation (from a second user) to play the game, an embodiment may connect the one or more selected contacts with the first user to play a multi user game. In some embodiments, the keyboard may be accessed from within any standard application on the touch screen device, for example, from within a social application, messaging or communications application.

Reference is now made to FIG. 1B, which shows a system and flows according to some embodiments of the invention. As shown, a system 100 may include user devices 140 and 150 that may include games application 160 and games keyboard 170. As further shown, system 100 may include applications server 130, games server 120 that may be operatively connected to games database (DB) 125. As shown, applications server 130 and games server 120 may be on the cloud, e.g., accessible to user devices 140 and 150 over the internet. For example, communications cloud 110 may be the internet or any other network that enables user devices 140 and 150, applications server 130 and games server 120 to communicate. It will be understood that a system according to some embodiments of the invention may include any number of user devices such as user device 140, applications servers such as applications server 130 and games server similar to games server 120. Applications server 130 and a games server 120 may be configured to communicate, over communications cloud 110, with any required or relevant data or application servers.

Games application 160 and games keyboard 170 may be or may include components of computing device 1000. For example, user devices 150 and 140 may include a controller 1005, a memory 1020 and a plurality of executable code segments similar to executable code 1025. Accordingly, each of games application 160 and games keyboard 170 may be, or may include, a controller (e.g., controller 1005), a memory (e.g., memory 1020) and executable code (e.g., executable code 1025). When executable code in games application 160 and/or games keyboard 170 is executed by the controller, it may cause the controller to carry out methods and operations as described herein. For example, games application 160 and/or games keyboard 170 may be applications, units or modules installed on user devices 150 and 140 as known in the art.

In an exemplary scenario shown by FIG. 1B, games keyboard 170 may present a soft keyboard on a screen of user device 140. For example, games keyboard 170 may replace a standard or other keyboard presented within, or in connection to, a chat application (e.g., WhatsApp) with a special soft keyboard. For example, games keyboard 170 or a configuration of user devices 150 and 150 may cause a special soft keyboard to be included in, or made part of a presentation of, any application or presentation of content that requires a keyboard. For example, as known in the art, a user (or application) may choose a default soft keyboard that will be used by a smartphone as the default soft keyboard. Games keyboard 170 may cause a special soft keyboard to be the default soft keyboard. For the sake of simplicity and clarity, WhatsApp will be mainly discussed herein when referring to an application of platform that enables users to communicate. However, it will be understood that any social application, social network, messaging application or social platform may be relevant, e.g., some embodiments of the invention may be implemented for, or used within messaging applications or platforms such as Line, Tango, Facebook Messenger, etc.

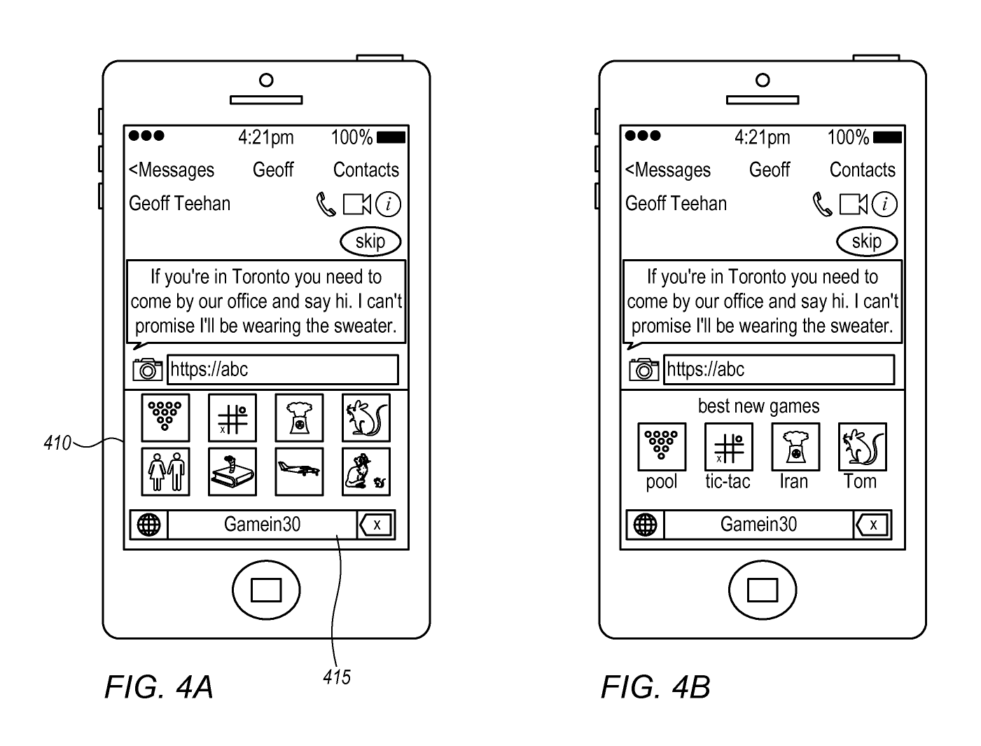

In some embodiments, games keyboard 170 or a configuration of user devices 150 and 150 may include, in a display of a standard (or default) soft keyboard, a display of a plurality of gaming icons for initiating a respective plurality of interactive games. In some embodiments, games keyboard 170 or a configuration may replace a standard (or default) soft keyboard by a special soft keyboard that includes a display of a plurality of gaming icons for initiating a respective plurality of interactive games. For example, gaming icons are shown by area 410 in FIG. 4B.

Various systems and methods may be used to present a special soft keyboard that includes a plurality of gaming icons. For example, games keyboard 170 may create, update, or otherwise maintain one or more files or other objects on a memory of user devices 140 and 150. Games keyboard 170 may include in a file or other object definitions and information usable for presenting the special soft keyboard. For example, icons to be presented, a list of games the user likes, a gaming history (games played, scores, other users who participated in a game) and the like may all be stored in a file or object.

To present a special soft keyboard, games keyboard 170 may read the file and use information and definitions in the file in order to present the special soft keyboard. In other embodiments, games keyboard 170 may dynamically define and update the special soft keyboard. For example, games keyboard 170 may communicate with games server 120, may receive, from games server 120, content definitions or parameters and may use information received from games server 120 to present a special soft keyboard.

Gaming icons presented may be clickable as known in the art. For example, when clicked, an icon in a special soft keyboard may enable a user of device 140 to engage in a game with a user of device 150. For example, in response to a click on an icon, a system and method according to some embodiments of the invention may send an invitation from an inviter (e.g., the user of user device 140) to an invitee (e.g., the user of user device 150). An invitation may prompt and enable to engage in an interactive, possibly competitive, online game.

For example, a click on one of gaming icons 410 may be captured by games application 160 or by games keyboard 170. Capturing a click event is known in the art, for example, games application 160 or by games keyboard 170 may receive a message or event when one of icons 410 is clicked where the message may include an identification of the icon clicked. Upon receiving an event related to a click on a gaming icon in a special soft keyboard, an embodiment may send a message to games server 120. For example, games application 160 sends a message to games server 120 when one of icons 410 is pressed.

Games server 120 may process a message, possibly using information in database 125 and may send a game request to one or more selected contacts of the user of user device 140. For example, if the user of device 140 clicks a gaming icon while in a chat session with a user of device 150, then the message sent to games server 120 may include an identification of the user of device 150. Accordingly, games server 120 may know to which user an invitation to play is to be sent.

A message sent to games server 120 may include an identification of an application. For example, a first and second users are currently in a chat session, using a specific application (e.g., WhatsApp). The first user clicks a gaming icon in a special soft keyboard presented as described. In such case, games application 160 or by games keyboard 170 may send a message to games server 120 and the message may include an identification of the second user and an identification of the specific application (e.g., WhatsApp) used. Accordingly, games server 120 may know to whom an invitation is to be sent and may further know what application is to be used for sending the invitation to the second user. For example, in the exemplary above scenario, an invitation to play may be sent to the second user over WhatsApp.

A message sent to games server 120 may include a link to the game, for example, a message may include a Uniform Resource Locator (URL) that points to a website where the game may be downloaded. In response to a selection of, or click on, a game (or gaming) icon, an embodiment of a system or method according to the invention may send, from an inviter to an invitee, code usable by the invitee to participate in an interactive or other game. For example, a message sent to games server 120 may include executable code (e.g., a code segment similar to executable code 1025) that may readily executed by a receiver or invitee (e.g., user #2 in FIG. 2 and FIG. 3).

In some embodiments, an invitation to play may be sent by, or via, application server 130. For example, if a message (or invitation) was sent from user device 140 to a user of user device 150 while the users of these devices were chatting over WhatsApp, then games server 120 may receive a parameter or value that indicates WhatsApp as the application currently used, accordingly, games server 120 may communicate with application server 130 that may be a WhatsApp server and/or application server 130 may send the invitation to user device 150 using WhatsApp application server 130.

Reference is now made to FIG. 2, which is a flow of game initiation in a social gaming platform according to some embodiments. As shown by block 205, a user #1 (e.g., a user of user device 140) may select to use a special soft keyboard while logged in to a social application (e.g., logged in to Facebook) or while using a messaging application, e.g., WhatsApp or Facebook messenger. For example, as known in the art, a user of a smartphone can select a soft keyboard to be used in an application. Accordingly, a special soft keyboard maintained or provided by games keyboard 170 as described may be selected as shown by block 205.

As shown by block 210, a user may click on a game (or gaming) icon to select a game to be played. A click on a gaming icon may be captured or intercepted by games application 160 as described. As shown by block 215, an invitation (that may include a link to the game) may be sent to one or more users. For example, in response to a selection of a game icon, a plurality of invitations to play an interactive game may be sent to a plurality of invitees. Games application 160 may present a list of suggested invitees based on various aspects. For example, suggested invitees may be selected based on their status (e.g., logged in to a specific application or network). Suggested invitees may be selected based on a relation with the inviter. For example, only users who are friends on Facebook may be selected. Suggested invitees may be selected based on a profile maintained for the invitees and/or based on a profile of the inviter. For example, for a specific game an inviter wants to play, suggested invitees may be selected if their respective profiles indicate they like the specific game (for example, a profile of a user may include ranking or scoring of games). A user profile as described herein may be, or may be stored in, a file or other object and may be provided to any unit in a system according to some embodiments of the invention. For example, user profiles may be, or may be included in a file stored locally (e.g., on user devices 140 and 150) or a user profiles may be, or may be included in a file stored on games database 125. Games server 120 may provide games applications with a profile of any user. Accordingly, selecting icons to be presented in a soft keyboard may be based on attributes, preferences or profile of a user, inviter and an invitee.

A suggested invitees list may be created by games application 160 or by games server 120. For example, games server 120 may create and update profiles for users. A profile may include any relevant information that may be used in order to suggest invitees for a game. For example, a profile may include the number of times a user invited others to play, was invited, won or lost games and so on. Accordingly, games application 160 may present a list of users that includes one or more of: a contact in a contact list of a smartphone, a friend in a social network, a user currently using a specific online application and a user in a list maintained by games application 160. Accordingly, a user may be enabled to invite other users to play by selecting users from a list of friends who are currently online, friends in Facebook, friends who are currently chatting on WhatsApp or other messaging application, friends who are currently logged in to (or active on) a specific social network and so on. For example, keyboard application 170 may determine or identify that a user is currently chatting on WhatsApp and may further identify which of the user's contacts are also currently chatting on WhatsApp (or have WhatsApp opened on their devices). Keyboard application 170 may include, in a list of suggested friends for a game, the friends or contacts that are currently on WhatsApp. Accordingly, a list of suggested partners to a game may be based on a set of users currently using a specific application.

An invitation to a plurality of invitees may include sending a message to a group of users. For example, if user #1 clicks a gaming icon in a special soft keyboard as described while chatting in a WhatsApp group, then a message sent to games server 120 as described may include an indication of the group and application server 130 may send the invitation to all users in the group. It will be understood that other methods used by applications to send a message to multiple users, e.g., broadcast as known in the art, may be supported by some embodiments of the invention in a similar way. As shown by block 220, an invitee may reject or ignore an invitation. Games server 120 may receive a reject from an invitee, may notify the inviter and may further update a profile of the inviter and/or invitee (e.g., record the time, game suggested, application used etc.). As shown by block 230, user #2 may accept the invitation to play. For example, games application 160 may receive an invitation from server 120 and may display the invitation on a screen of user device 150. A presentation of an invitation may include an accept button that, when clicked, may carry the invitee to the game as described herein.

As shown by block 235, a notification (or an acceptance indicating) that an invitee (user #2) wants to play may be delivered to the inviter (user #1). For example, clicking on an accept button may cause games application 160 in an invitee's computing device to send a message to server 120 who may, upon receiving an accept message, send a notification to games application 160 in the inviters computing device. Games application 160 may present the notification (e.g., including the name, picture or avatar of the invitee) to the inviter. In some embodiments, an invitation as described with reference to block 215 may include information usable for communicating directly with a computing device of the inviter (e.g., an internet protocol (IP) address, a port and so on). Accordingly, games application 160 in an invitee's computing device (e.g., user device 150) may communicate directly with a games application 160 in an inviter's computing device (e.g., user device 150). It will, therefore, be understood that messages that are or that include an invitation, an acceptance of an invitation and the like may be communicated directly between instances of games application 160 on different computing devices.

As shown by block 240, an inviter (e.g., user #1) may click a button to initiate the game. For example, if an acceptance from an invitee was received, a GUI button may be presented to the inviter and, upon receiving a click of the inviter as known in the art; games application 160 may initiate an interactive game between user #1 and user #2. For example, games applications 160 on both user devices 140 and 150 may launch (or cause execution of) instances of the game application. In some embodiments, games server 120 is a multi-player game server, and causing an inviter and one or more invitees to engage in the same game (or session) may be done using a multi-player game server as known in the art. For example, as known in the art, a link sent from user device 140 to user device 150 may point to a game session on games server 120 and may be used to engage users of user devices 140 and 150 in a game.

Accordingly, according to some embodiments of the invention, one touch on a game icon on a first user's touchscreen can initiate sending an invitation (and enablement) to play a game, wherein if the recipient of the invitation presses an accept button, the game between these 2 or more players starts.

Reference is now made to FIG. 3, which is a flow of game initiation in according to some embodiments. As shown by block 305, a user #1 (e.g., a user of user device 140) may select to use a special soft keyboard while logged in to a social application (e.g., WhatsApp or Facebook). As shown by block 310, an invitation may be sent to one or more users or invitees as described herein. For example, in a social app where a user has groups of contacts, like WhatsApp groups, an invitation to play a game can be sent to one or more groups. As shown by block 320, if user #2 is online, or logged into a specific social application (e.g., the same social application the invitee is currently in), a message or invitation may be provided to user #2, e.g., as described herein with reference to block 215 in FIG. 2. As shown by block 325, an indication of acceptance may be received from user #2 (the invitee), e.g., as described herein with reference to block 230 in FIG. 2.

As shown by block 330, an embodiment may determine whether or not a computing device can execute or support a game. For example, as known in the art, a game may need to be downloaded to a device in order to be played (or executed). For example, games application 160 may check user computing device 150 and determine whether or not the a binary (executable code) for running the game is present, or games application 160 may check whether or not the game is installed in an invitee's device. As shown by block 365, if an invitee's device can readily enable to invitee to engage in the game, an embodiment may include the invitee in the game, e.g., as described with reference to block 240 in FIG. 2. As shown by block 360, if a device of an invitee cannot enable the invitee to participate in the game, an action may be performed, e.g., by games application 160. For example, an invitee may be referred to a website or an application store as known in the art where the invitee can download the game.

As shown by block 345, if an invitee is not logged into a social application or network (e.g., user #1 is on Facebook but user #2 is currently offline), the an invitation may be sent to the invitee over the social network. An invitation may be accepted at any time, e.g., immediately when received or at a later time. For example, an invitation may be sent as described and only seen at a later time (e.g., half an hour later) by the invitee. An invitee may accept an invitation at any point in time.

An invitee may respond to, or accept, an invitation at any time provided an expiry time or date set by an inviter have not elapsed. For example, upon selection of a game and/or partner for a game, keyboard application 170 may present a user with a selection of an expiry time, date or duration. For example, a user may send an invitation and set an expiry time of five minutes for the invitation. If an invitation is not accepted within an associated expiry time, the invitation may be canceled. For example, upon expiry of an invitation that was not accepted, games application 160 on the inviter's computing device may inform games application 160 on the invitee's computing device that the invitation is cancelled and games application 160 on the invitee's computing device may remove the invitation.

As shown by block 350, at some point (e.g., when user #2 is back online or logged into Facebook), the invitee may accept an invitation, e.g., receive and accept an invitation as described with reference to block 325.

Reference is now made to FIG. 4A and FIG. 4B, which show exemplary screenshots according to some embodiments of the invention. For example, in accordance with some embodiments of the invention, the screens as shown by the screenshots in FIGS. 4A and 4B may be presented to a user in a typical portable multifunction device. For example, a portable multifunction device (e.g., user devices 140 and 150) may be an IOS device, an Android device, or a device running any other suitable operating system.

As shown by block 410, a gaming keyboard may be displayed on a touch screen device, showing icons or links to multiple games. It will be understood that any number of icons as shown by block 410 may be presented. For example, the number of gaming icons may be automatically set (e.g., by keyboard application 170) based on the size of a display or icons' size may be reduced in order to increase the number of icons displayed. As shown by block 415, a soft keyboard may be given a name and the name may be presented to a user. For example, in FIG. 4A and FIG. 4B, the gaming soft keyboard is named “Gamein30”, which is an example of a genre of short, ˜30 second games, however other games lengths, types etc. may be used.

In some embodiments, the GUI or user interface may be personalized, adjustable, customizable, dynamically changing based on user behavior, for example, based on games which were played in the past. In other embodiments, third parties games (e.g., an original equipment manufacturer (OEM)) may be integrated into the keyboard, optionally on an on-going basis (e.g. subject to updates of the keyboard).

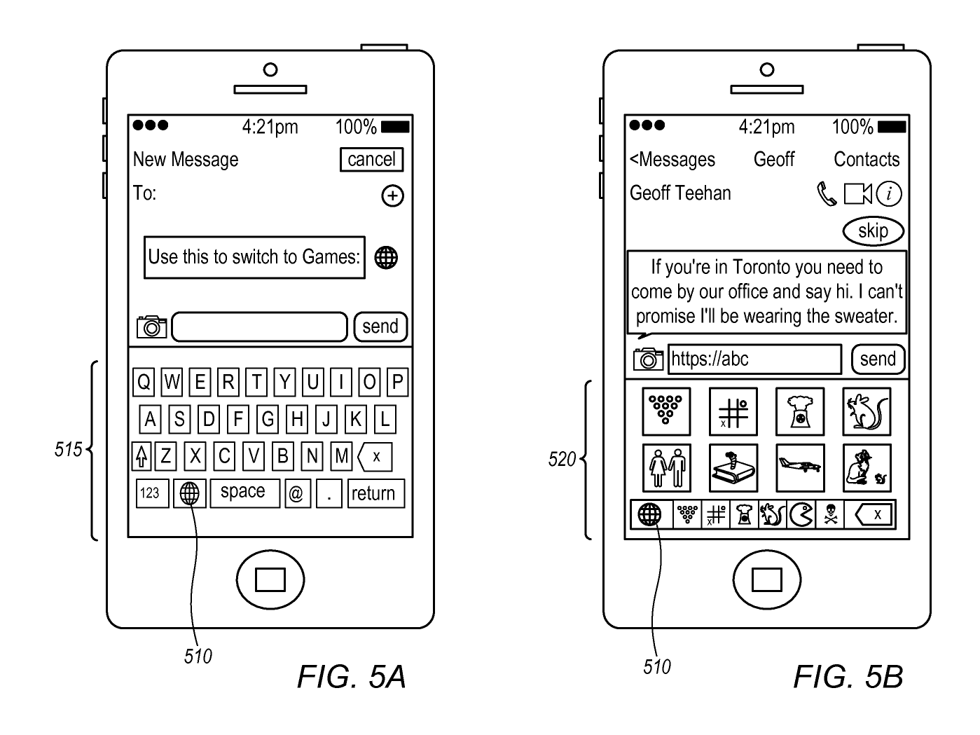

Reference is now made to FIG. 5A and FIG. 5B that show exemplary screenshots according to embodiments of the invention. For example, in accordance with some embodiments of the invention, the screens as shown by the screenshots in FIGS. 5A and 5B may be presented to a user by a smartphone as known in the art.

As shown by block 515, a QWERTY soft keyboard as known in the art may displayed, e.g., games keyboard 170 may display the soft keyboard as shown by block 515. According to some embodiments, a single icon in a soft keyboard may be operable to display a plurality of gaming icons where the single icon is included or integrated in, or is part of, the soft keyboard.

As shown by button 510, a button (that may be, or act as, a toggle button as known in the art) may be used to cause a display of gaming icons as shown by block 520. For example, clicking on button 510 from within keyboard 515 may cause a presentation of gaming icons as shown by block 520. Clicking on button 515 when gaming icons as shown by block 520 are shown may switch back to soft keyboard 515. Any number of icons may be displayed as shown by block 520. For example, based on a configuration of keyboard application 170, the number of icons may be increased or decreased.

Gaming icons as shown by block 520 may be scrolled as known in the art. For example, the items in block 520 may be scrolled left or right, or up and down. Categories of games may be selected and an embodiment may present game icons according to a category selection of a user, e.g., according to categories such as puzzles, arcades, sports, trivia etc.

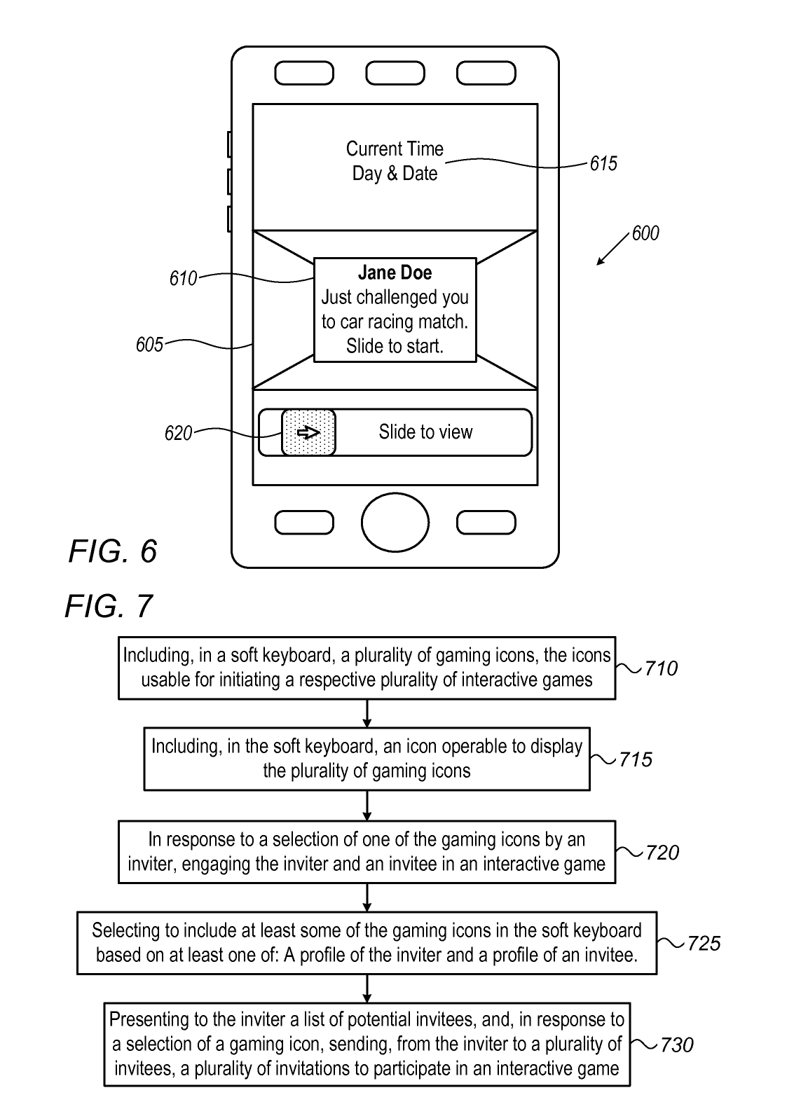

Reference is now made to FIG. 6, which is a schematic diagram depicting an exemplary layout of a screen presented to a user in accordance with some embodiments. For example, user device 150 may present a screen as shown by FIG. 6. As shown by block 605, an invitation may include a time parameter as shown by block 615. For example, a time parameter as shown by block 615 may be the current date and time or it may be a stopwatch or a countdown as known in the art, e.g., indicating until when the invitation is valid. As shown by block 610, a presentation of an invitation may include a message or text. For example, a message or text displayed as shown by block 610 may include a description of the inviter, free text entered by the inviter and so on.

An invitee may enable a user to see or watch a game. For example, a user may use slide 620 to view the game, possibly without participating in the game. For example, games application 160 may use games server 120 to enable a user to view a game when an event from slide 620 is received. Optionally, clicking on a button (e.g., any of blocks 615, 610 and 605 may be clickable as known in the art), a user may indicate acceptance of the invitation and may be carried into the game as described herein. As described, pressing on a game icon by an inviter may send or share the game, invite one or more invitees, engage in a game or match and so on. Accordingly, some embodiments of the invention enable users of substantially any mobile device to send, share, and play against each other, games, through their gaming keyboard.

According to some embodiments of the invention, selecting at least some of the plurality of gaming icons to be presented to a user may be based on attributes or a profile of a user. For example, based on a profile of the invitee, games application 160 may select specific games and present icons of the selected games to an inviter. Games may be selected based on attributes or profile of a potential or possible invitee. For example, if an inviter is currently chatting (e.g., on WhatsApp) with a friend, then, when the inviter clicks button 510 as shown in FIG. 5, the list of gaming icons may be created based on a profile of the friend, based on the profile of the inviter or based on both profiles. For example, if both the profiles of the inviter and the friend indicate that they both like a particular game (or categories of games), then games applications 160 may include icons of the particular game (or categories of games) in the gaming icons (e.g., as shown by block 520 in FIG. 5).

As described, some embodiments may select gaming icons to be presented from within a soft keyboard based on input, attributes, profile or other aspects related to a user. For example, user preferences (e.g., favorite games, genres, themes and the like) may be received from a user, stored in a profile and used in order to select games and gaming icons as described.

A profile of a user (inviter and invitees) may include a history of games played (e.g., inserted into the profile by games applications 160 or games server 120), user preferences, user's age, gender and the like. Accordingly, a set of gaming icons presented to a user may be personalized based on a profile, e.g., keyboard application 170 may select games and icons for presentation based on a profile. As described, a user profile may be maintained locally (e.g., on device 140) or on a server (e.g., games server 120). Games applications 160 or keyboard application 170 may receive from games server 120 a profile of a user (e.g., a profile of a potential or probable invitee as described). Accordingly, a list or set of games presented from within a soft keyboard may be created or defined based on user's profiles.

According to some embodiments, a profile of a user may be updated dynamically, e.g., based on a behavior of a user. For example, if an inviter or invitee quits a game before it is over, an embodiment may mark the game, e.g., indicate the user does not like the game. In another case, if a user often selects a particular game, the game may be marked, in the user's profile, as a favorite, or the game may be associated with a high score etc. Based on games a user likes, games server 120 may identify a category of similar games and games from the category may be suggested to the user, e.g., included in future presentations of gaming icons 510 as discussed herein.

In some embodiments, the games featured on a soft keyboard as described may have, or be associated with, a time parameter. For example, an invitation may have a limited time span, for example, an invitation may be configured with a time limit for invitation activation such that the invitation is usable by an invitee for a limited time period. For example, based on a configuration parameter, games application 160 may include a time limit in a message sent to games server 120 as described. In some embodiments, games application 160 may include a time limit received from a user in a message to games server 120. For example, an inviter may select 30 seconds when sending an invitation as described, games application 160 may include the selection in an invitation created and sent to an invitee as described, and games applications 160 on the invitees computing device may present the invitation with a time countdown (e.g., as shown by block 615). If the invitee did not accept an invitation by the specified time, games applications 160 may terminate a display of the invitation. For example, in the exemplary 30 seconds scenario described above, games applications 160 in the invitees computing device may wait for acceptance from the invitee for 30 seconds and, if no acceptance was received or detected, remove the display of the invitation.

A soft keyboard and gaming icons as described herein may be used by some embodiments of the invention to enable a user to connect to a games server or otherwise start a game (e.g., a game downloaded end executed locally) and play a game alone, or with unknown other users, e.g., playing an online game using a games server as known in the art.

For example, in response to detecting a selection of a game icon in a soft keyboard as described, games application 160 may connect a user to game server 120 and the user may play the game on server 120 as known in the art. For example, when clicking one of the game icons as shown in block 520, a popup menu may enable a user to select one of “play” and “invite”, if the user wants to play the game without inviting a friend, the user may select “play” and in response, games application 160 may connect the user to games server 120 and the user may play the game on server 120 as known in the art. If the game can or should be executed locally, games application 160 may download the game if needed and/or execute or launch the game. Accordingly, some embodiments of the invention may be applied to any gaming method or scheme as known in the art.

In some embodiments, payment may be requested from a user and the user may be enabled to join a game only if payment was received. In some embodiments, advertisements may be embedded on the soft keyboard. In some embodiments, games may be promoted on the gaming soft keyboard, for example, by placing advertised games in prominent positions on the gaming soft keyboard.

Reference is made to FIG. 7, which shows a flowchart of a method according to some embodiments of the present invention. As shown by block 710, a plurality of gaming icons may be included or integrated in a soft keyboard wherein the gaming icons are usable for initiating interactive games. For example, gaming icons as shown by block 410 in FIG. 4A and block 520 in FIG. 5B may be included or integrated in a soft keyboard. As described, the gaming icons shown by blocks 410 and 520 may be usable initiate an interactive or other online game.

As shown by block 715, an icon usable or operable for displaying plurality of gaming icons may be included or integrated in a soft keyboard. For example, based on a configuration, rather than always displaying (or integrating or including) the plurality of gaming icons in a soft keyboard, a single icon (e.g., as shown by icon 510 in FIG. 5A) may be used (integrated or included in a soft keyboard) in order to display, integrate or include the plurality of gaming icons in the soft keyboard. For example, a user may want to clear or remove the display of the gaming icons from a soft keyboard (e.g., to get more space in the soft keyboard) and only bring up the gaming icons when he or she wishes to play. For example, icon 510 in FIG. 5A and FIG. 5B may act as a toggle button that displays and hides the gaming icons shown by block 520 in FIG. 5B.

As shown by block 720, a system and method according to some embodiments of the invention may engage and inviter and an invitee in an interactive game upon, or in response to, a selection of, or click on, one of the gaming icons presented in a soft keyboard. For example, engaging users in an interactive game may include sending an invitation as described, accepting an invitation and establishing a session of an interactive game using a games server as described herein.

As shown by block 725, gaming icons (and consequently, interactive games) may be selected based on a profile of an inviter and/or based on a profile of an invitee. For example, if user “A” is currently chatting with user “B” on WhatsApp then the set of gaming icons presented to user “A” may be icons of games both user “A” and user “B” like. A set of icons may be selected and presented to a user based on profiles of any number of users, e.g., icons for games that all members of a WhatsApp group like may be presented. As described, profiles may be maintained for users as known in the art (e.g., on games server 120) and games application 160 or keyboards application 170 may receive, from a server, profiles of users or receive lists of games users like. Accordingly, a set of gaming icons related to a set of games may be defined and presented based on any criteria or rule, including preferences of an inviter and a set of invitees.

As shown by block 730, a list of potential invitees may be presented to an inviter and, in response to a selection of a game (by clicking on one of the gaming icons), a plurality of invitations may be sent to a plurality of invitees, e.g., using broadcasting of messages as known in the art. For example, broadcasting may include sending one message (e.g., an invitation) and a list of recipients to a server and the server may send the message to each of the recipients. An interactive game may include any number of players, e.g., all invitees that accept an invitation may be engaged in an interactive game as described.

In some embodiments, keyboard application 170 may enable a user to search for games. For example, a box for entering text may be presented or included in a soft keyboard enabling a user to search for games, e.g., based on a name of a game, a genre of games and so on.

Gaming icons may be presented by categories. For example, a list or set of categories of games may be displayed and, upon selection of a category, gaming icons for the selected category may be presented as described herein. As described, gaming icons may be presented based on user preferences. For example, keyboard application 170 may receive preferences from a user (e.g., in the form of genres, categories and the like) and may select gaming icons based on the preferences.

A system and method according to some embodiments of the invention may include, on an electronic device with a touch screen display, displaying a predefined keyboard display area operable to display a plurality of gaming icons for initiating a game; and in response to detecting a selection of a game icon, connecting a first user to a game server to launch a game. For example, gaming icons included in a soft keyboard may be used by a user to play a game on games server 120, e.g., a game played by one user, not necessarily an interactive game that involves two or more players.

A keyboard display area may be used to launch a multi-player game, by, in response to detecting a selection of a game icon, connecting a first user to a second user to launch a multi-player game between at least the first and second users. For example, a game that includes users of user devices 140 and 150 may be launched as described. A game may be launched for, and played by, a plurality of users, a group of users, and multiple groups of users. A connection of a first user to a second user may be enabled from inside a social application, using the first user's connections contactable through the social application.

A method for enabling gaming on a touch screen device according to some embodiments of the invention may include running one or more files with instructions to present a soft gaming keyboard as part of a user interface on a display area of a device, the soft keyboard including a plurality of linked gaming icons; upon clicking on an icon by a first user, initiating an invitation to play the selected game with one or more selected contacts; upon selecting one or more contacts, communicating a request to play the selected game with the first user; and upon agreeing to play the game, connecting the one or more selected contacts with the first user to play a multi user game.

According to some embodiments of the invention, displayed icons or elements in a soft keyboard may be changed or selected in accordance with user behavior, e.g., a history of games played, games the user marked as favorites etc.

According to some embodiments of the invention, a soft keyboard that includes gaming icons may be used by any standard application on a touch screen device, e.g., a messaging application as known in the art. According to embodiments of the invention, a time limit for an invitation may be set and the invitation may expire upon expiry of the time limit.

According to some embodiments of the invention, a time limit may be set for a game and the game may be terminated based on the time limit. For example, a time limit of 30 seconds may be set by an invitee or by games application 160 and a game that may started by selecting an icon in a soft keyboard as described may be terminated based on the time limit, e.g., after 30 seconds. According to some embodiments of the invention, advertisements may be presented in the soft keyboard.

According to some embodiments of the invention, a touch screen device may include a display screen; a processor including a file with instructions to execute commands to enable execution or presentation of a virtual gaming keyboard (or soft keyboard) on the display screen, the gaming keyboard comprising multiple gaming links that may be configured to link to a game server upon selection by a user. According to embodiments of the invention, a system may include a social application for enabling access to a user's contacts, and for initiating gaming communication with a user's contacts, via a messaging application.

According to some embodiments of the invention, a gaming or soft keyboard may be configured to personalize gaming links in accordance with user behavior. For example, gaming icons may be selected and presented based on a user's profile as described or based on user preferences as described.

Unless explicitly stated, the method embodiments described herein are not constrained to a particular order in time or chronological sequence. Additionally, some of the described method elements may be skipped, or they may be repeated, during a sequence of operations of a method.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of gaming, comprising:
including, in a display of a soft keyboard, a display of a plurality of gaming icons for initiating a respective plurality of interactive games; and
in response to a selection of a game icon by an inviter, engaging the inviter and an invitee in an interactive game.

2. The method of claim 1, comprising, including, in the soft keyboard, an icon operable to display the plurality of gaming icons.

3. The method of claim 1, wherein the soft keyboard is used, within an application, to generate content.

4. The method of claim 1, comprising, in response to the selection of a game icon, sending, from the inviter to an invitee, an invitation to participate in the interactive game.

5. The method of claim 1, comprising, in response to the selection of a game icon, sending, from the inviter to an invitee, a link usable by the invitee to participate in the interactive game.

6. The method of claim 1, comprising, in response to the selection of a game icon, sending, from an inviter to a plurality of invitees, a plurality of invitations to participate in the interactive game.

7. The method of claim 1, comprising, presenting to the inviter a list of potential invitees, the list including at least one of: a contact in a contact list, a friend in a social network, a user currently using a specific online application and a predefined list.

8. The method of claim 1, comprising, selecting at least some of the plurality of interactive games based on at least one of: a profile of the inviter and a profile of an invitee.

9. The method of claim 4, wherein the invitation is usable by the invitee for a limited time period.

10. A device comprising:
a memory; and
a controller, the controller configured to:
include, in a display of a soft keyboard, a display of a plurality of gaming icons for initiating a respective plurality of interactive games; and
in response to a selection of a game icon by an inviter, engage the inviter and an invitee in an interactive game.

11. The device of claim 10, wherein the controller is configured to include, in the soft keyboard, an icon operable to display the plurality of gaming icons.

12. The device of claim 10, wherein the soft keyboard is used, within an application, to generate content.

13. The device of claim 10, wherein the controller is configured to, in response to the selection of a game icon, send, from the inviter to an invitee, an invitation to participate in an interactive game.

14. The device of claim 10, wherein the controller is configured to, in response to a selection of a game icon, send, from the inviter to an invitee, a link usable by the invitee to participate in the interactive game.

15. The device of claim 10, wherein the controller is configured to, in response to a selection of a game icon, send, from an inviter to a plurality of invitees, a plurality of invitations to participate in the interactive game.

16. The device of claim 10, wherein the controller is configured to, present to the inviter a list of potential invitees, the list including at least one of: a contact in a contact list, a friend in a social network, a user currently using a specific online application and a predefined list.

17. The device of claim 10, wherein the controller is configured to, select at least some of the plurality of interactive games based on at least one of: a profile of the inviter and a profile of an invitee.

18. The device of claim 13, wherein the invitation is usable by the invitee for a limited time period.
